(19) United States
(12) Patent Application Publication
(10) Pub. No.: US 2009/0122707 A1
(43) Pub. Date: May 14, 2009

(54) Multi-layer cascading network bandwidth control

(75) Inventor: Joseph Weinman, Basking Ridge, NJ (US)

Correspondence Address: AT&T Legal Department - HB;Patent Docketing, One AT&T Way, Room 2A-207, Bedminster, NJ, 07921, US

(73) Assignee: AT&T Services, Inc.

(21) Appl. No.: 11/985,317

(22) Filed: Nov. 13, 2007

(51) Int. Cl. G08C 15/00

(52) U.S. Cl. 370/237

(57) ABSTRACT

A managed communication system is disclosed. The system includes a network having a plurality of layers, such as layers 1, 2, 3, through layer n. Each layer requests and receives services from the layer directly below it. A control module is provided that interacts with the components of each layer. Preferably, each layer exposes one or more flexibility attributes, e.g., route control, bandwidth control, QoS control, or other attributes. A monitoring module is also provided that measures network traffic on ingress to each layer and accepts requirements associated with such traffic

### BACKGROUND OF THE INVENTION

1. Field of the Invention

The present invention generally relates to computer network control, and more particularly to coordinated bandwidth control of network layers.

2. Brief Description of the Related Art

Voice, data, and converged voice and data networks are ubiquitous. For example, the Internet permeates virtually everyone's life today. Cellular data services, such as Short Message Service (SMS) and Multimedia Message Service (MMS) are widely used, and private networks, such as Virtual Private Networks (VPNs) are used to connect enterprise data centers, headquarters, branch locations, employees, and partners.

Typically, networks have a layered structure to them. For example, at the lowest layer there may be a photonic mesh where information is transmitted as optical pulses. The information is transmitted with the aid of transport facilities that operate as “pipes” into which a sequence of information is sent. A receiver then receives the information out the opposite end of the pipe in the same order as it was sent. Also, routing, switching, and cross-connects enable interconnections among pipes.

Higher network layers, such as a bandwidth layer, e.g., Synchronous Optical Network/Synchronous Digital Hierarchy (SONET/SDH) or Internet Protocol/Multi-Protocol Label Switching (IP/MPLS), provide both additional information, such as destination, Quality of Service (QoS) indicators, Virtual Routing and Forwarding (VRF), and additional functionality, such as multicasting.

Whereas traditional networks have tended to be point-to-point, today's networks have substantial flexibility, both in terms of the routes that are followed to transmit information from point A to point B, or from point A to points B1, B2, and B3, as well as the available bandwidth, QoS, and other network characteristics. This flexibility requires control to direct the network to route information from point A to point B via point C rather than point D, or to allocate or add an additional increment of bandwidth for a particular route.

However, traditional layered networks are built with individual control structures at each layer. For example, in some networks, the photonic mesh layer includes its own control module that indicates how to structure routes using available cross-connects and facilities (pipes), including both physical facilities, such as a fiber pair connecting Cleveland and Dallas, as well as virtual facilities, e.g., a particular wavelength of light traveling on that fiber or a particular timeslot for Time Division Multiplexed facilities such as SONET.

Consequently, one control module is used to manage the lowest layer, another control module is used to manage the next layer immediately above that layer, and so forth. Multiple control modules can create inefficiencies due to lack of communication between network layers. For example, a certain virtual network could need additional bandwidth at one moment in time, and at the same point in time, another virtual network may need additional bandwidth as well. Without the ability to direct a lower layer to provision more bandwidth using routes or links available to it, both virtual networks could be denied the bandwidth they need.

Accordingly, there exists a need for centralized control of network routing, switching, and transport layers based on requirements driven by higher network layers, whether those requirements increase, decrease, or are reallocated.

### SUMMARY OF THE INVENTION

A managed communication system is disclosed. The system includes a network having a plurality of layers, such as layers 1, 2, 3, through layer n. Each layer requests and receives services from the layer directly below it. A control module is provided that interacts with the components of each layer. Preferably, each layer exposes one or more flexibility attributes, e.g., route control, bandwidth control, QoS control, or other attributes. A monitoring module is also provided that measures network traffic on ingress to each layer and accepts requirements associated with such traffic, e.g., Class of Service, which is a technique for managing a similar type of traffic.

Preferably, at each layer of the network, if more traffic with given requirements is requested of a layer than it can efficiently process, the control module executes a method that requests additional bandwidth along existing routes. If insufficient bandwidth is available, the control module preferably requests bandwidth along additional routes. In one preferred embodiment, if no other routes are available, the control module requests reapportionment of various classes of service to reduce bandwidth allocated to lower classes of service. Preferably, if there are no other classes of service available, the control module generates an error message.

Conversely, if bandwidth required at a layer m is reduced, the control module executes the reverse process, where a lower Class of Service can be allocated additional bandwidth in accordance with its requirements. If additional bandwidth is not necessary, the control module can reduce non-preferred route bandwidth, and if this bandwidth drops to zero, free up the route. Accordingly, bandwidth on one or more preferred routes can be reduced.

Various aspects of the invention relate to monitoring and controlling a plurality of network layers. For example, according to one aspect, a network controller includes a computing device adapted to be operatively coupled to first and second network elements associated hierarchically in layers, the second network element having greater hierarchical priority than the first network element. The computing device adapted to modify allocation of a network resource in response to a request from the second network element.

Preferably, the network resource comprises at least one of a route control, a bandwidth, and a Quality of Service. In one preferred embodiment, at least one of the first network element and the second network element is selected from the group consisting essentially of an access router, edge router, core router, label switch, layer 2 switch, layer 3 switch, XML (extensible Markup Language) switch, dense wave division multiplexer, TCP/IP software stack, coarse wave division multiplexer, Asynchronous Transfer Mode (ATM) switch, frame relay access device, SONET multiplexer, inverse multiplexer, residential gateway, storage switch, storage virtualizer, optical cross-connect, reconfigurable optical add drop multiplexor, and wireless access point.

Preferably, the computing device specifies routes for at least one of the first and second network elements. In one preferred embodiment, the controller adjusts at least one of link capacity and end-to-end path capacity of at least one of the network elements. In another preferred embodiment, the controller is adapted to modify the allocation of available bandwidth.

In one preferred embodiment, the controller monitors the first and second network elements. Preferably, the controller further includes a plurality of transceivers adapted to send and receive network management information to at least one of the first and second network elements.

In another aspect, a method of controlling a network includes modifying an allocation of a network resource in response to a request from a second network element operatively coupled in hierarchical layers with a first network element, the second network element comprising greater hierarchical priority than the first network element. The method can also include monitoring each of the first and second network elements.

Preferably, the method includes determining whether additional bandwidth is available from the first network element on a data path between the first and second network elements, and allocating the additional bandwidth on the data path based on the determination. The can also include determining whether additional bandwidth is available from the first network element on a data path between the first and second network elements, and allocating the additional bandwidth on an alternative data path based on the determination.

In one preferred embodiment, the method also includes determining whether bandwidth is available from the first network element on a data path, and reallocating the bandwidth on the data path to a different class of service. The method can also include generating an alert based on a non-availability of bandwidth from the first network element.

Preferably, the method also includes determining whether additional bandwidth is to be allocated to a lower class of service along a data path between the first and second network elements, and allocating the bandwidth on the data path based on the determination. In one preferred embodiment, the method includes determining whether a first amount of bandwidth associated with a class of service is available on a preferred data path between the first and second network elements, and reallocating a second amount of bandwidth associated with a less preferred data path based on the determination.

Preferably, the method also includes providing a status of any allocation, reallocation, reclassification or rerouting of data paths between the first and second network elements.

In yet another aspect, an article comprising a machine-readable medium storing machine-readable instructions that, when applied to a machine, cause the machine to modify an allocation of a network resource in response to a request from a second network element operatively coupled in hierarchical layers with a first network element, the second network element comprising greater hierarchical priority than the first network element. Preferably, the article includes instructions that, when applied to the machine, cause the machine to monitor the first and second network elements.

In one preferred embodiment, the article includes instructions that, when applied to the machine, causes the machine to determine whether additional bandwidth is available from the first network element on a data path between the first and second network elements, and allocate the additional bandwidth on the data path based on the determination. The article can also include instructions that, when applied to the machine, cause the machine to determine whether additional bandwidth is available from the first network element on a data path between the first and second network element, and allocate the additional bandwidth on an alternative data path based on the determination. Preferably, the article also includes instructions that, when applied to the machine, cause the machine to determine whether bandwidth is available from the first network element on an existing data path, and reallocate the bandwidth on the data path to a different class of service.

Several benefits can be derived from the present invention. For example, intelligent coordination of what have traditionally been multiple uncoordinated, manually provisioned, and/or uncontrollable network layers can be achieved. Furthermore, the present invention can increase customer and core network optimization, as well as improve network throughput and lower cost.

Other objects, features and benefits of the present invention will become apparent from the following detailed description considered in conjunction with the accompanying drawings. It is to be understood, however, that the drawings are designed as an illustration only and not as a definition of the limits of the invention.

### BRIEF DESCRIPTION OF THE DRAWINGS

FIG. 1 is a block diagram of a system to control a multilayer network according to the present invention.

FIG. 2 is a block diagram that shows control and monitoring modules of the present invention.

FIG. 3 is a flow chart of a method executed by the present invention.

Like reference symbols in the various drawings indicate like elements.

### DETAILED DESCRIPTION OF THE PREFERRED EMBODIMENTS

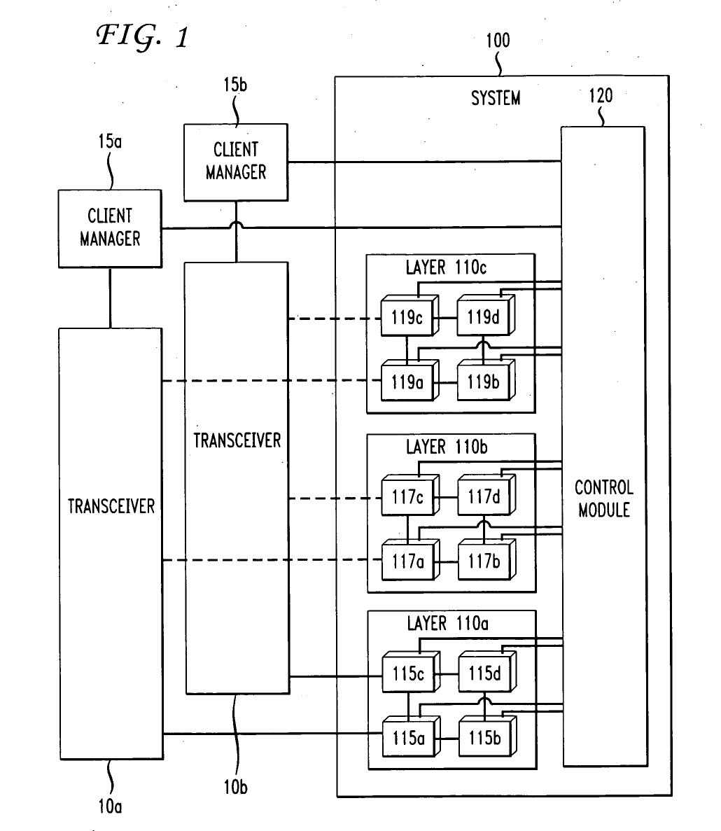

FIG. 1 illustrates a managed communication system 100 according to the present invention. As shown in FIG. 1, the system 100 can be used in combination with a customer's transmitters, receivers, or both, shown as transceivers 10a and 10b, and client management software 15a and 15b, hereinafter referred to as client managers 15a, 15b, for administration of the network. Although only two transceivers 10a, 10b and client managers 15a, 15b are shown in FIG. 1, the present invention is not limited to two transceivers and two client managers and can include a lesser or greater amount of transceivers and client managers.

As shown in FIG. 1, the system 100 includes a set of network layers 110a-c that is operatively coupled to a control module 120. Preferably, the network layers are arranged hierarchically in layers to form a multilayer network. Each network layer 110a-c includes one or more network elements 115a-d, 117a-d, 119a-d. Preferably, network element 119d has greater hierarchical priority than network element 117d. Similarly, network element 117d has greater hierarchical priority than network element 115d. For example, network layer 110a includes network elements 115a, 115b, 115c, and 115d, although in practice, each layer may have a lesser or greater number of elements. Each network element 115a, 115b, 115c, 115d may communicate with other network elements 115a, 115b, 115c, 115d as well as transceivers 10a-b. It will be appreciated that any of network elements 115a, 115b, 115c, 115d, can be an access router, edge router, core router, label switch, layer 2 switch, layer 3 switch, XML (eXtensible Markup Language) switch, dense wave division multiplexer, TCP/IP software stack, coarse wave division multiplexer, Asynchronous Transfer Mode (ATM) switch, frame relay access device, SONET multiplexer, inverse multiplexer, residential gateway, storage switch, storage virtualizer, optical cross-connect, reconfigurable optical add drop multiplexor, wireless access point, or other network elements as are known in the art for switching, routing, transmission, and related actions related to voice, data, video, and/or converged communications.

Layer 110b can include network elements that are physical hardware, firmware, or software. Preferably, higher layer functions of the network rely on lower layer functions, with data being framed, packetized, and otherwise encapsulated as it is handed off to lower layers, and sequenced, assembled, and de-encapsulated as it is handed off to higher layers. Thus, layer 110b relies on services provided by layer 110a, layer 110c relies on 110b, and layer 110n relies on layer 110(n-1). For example, in one preferred embodiment, layer 110c includes network elements 119a, 119b, 119c, 119d, which are preferably IP/MPLS Label Switched Routers, layer 110b includes SONET add/drop muxes 117a, 117b, 117c, 117d, and layer 110a includes photonic mesh elements such as reconfigurable optical add/drop multiplers, optical cross-connects, and long haul fiber, amplifiers, attenuators, filters, regenerators, and the like.

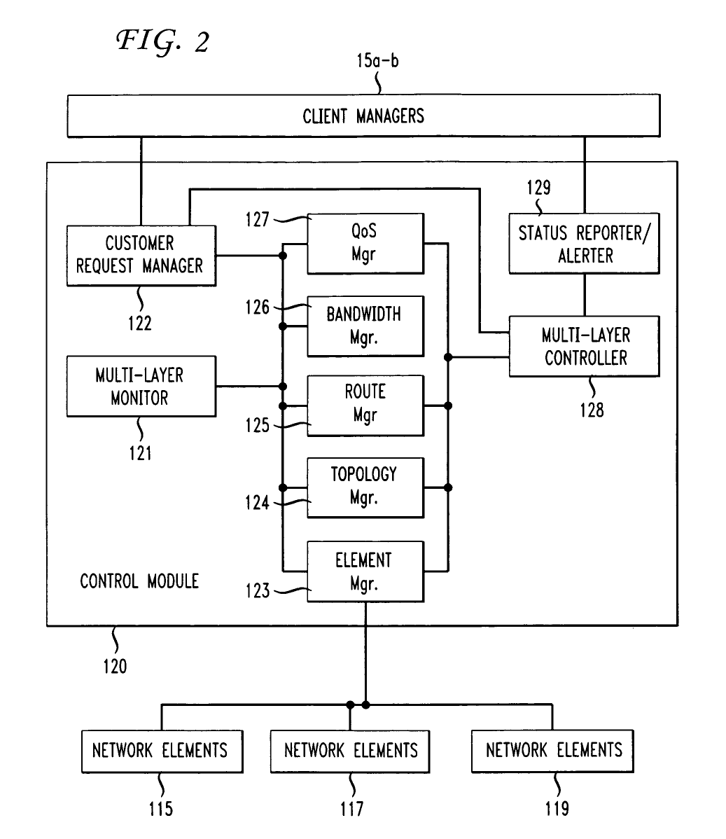

As shown in FIG. 2, control module 120 or computing device interacts with network elements 115a, 115b, 115c, 115d, hereinafter referred to and shown in FIG. 2 as 115, 117a, 117b, 117c, 117d, hereinafter referred to and shown in FIG. 2 as 117, 119a, 119b, 119c, 119d, hereinafter referred to and shown in FIG. 2 as 119 in several ways. First, discovery of network elements may occur as network elements 115, 117, 119 advertise, or otherwise inform, or are discovered by control module 120. Second, parameters associated with network elements, are provided from network elements 15, 117, 119 to control module 120. Such parameter information may include route discovery, current configuration, faults, congestion, packet loss, or other network status information as is known in the art, route control information, bandwidth control information as well as QoS control information. Thirdly, control module 120 can direct network elements 115, 117 and 119. For example, in some preferred embodiments, the control module 120 injects specific routes into the network elements 115, 117, 119, adjusts link capacity and also end-to-end path capacity, and adjusts the amount of bandwidth available in one or more virtual routes, Storage Area Networks (SANs), or Local Area Networks (LANs) on each route for each class of service.

As shown in FIG. 2, the control module 120 interacts with client managers 15b. In one preferred embodiment, the client managers 15b provide requirements and requests to the control module 120, and the control module 120 may provide status or alerts to client managers 15x.

Referring now to FIG. 2, details of the control module 120 of the present invention are shown. In one preferred embodiment, as shown in the FIG. 2, the control module 120 includes a multi-layer monitor 121, customer request manager 122, element manager 123, topology manager 124, route manager 125, bandwidth manager 126, quality of service manager 127, multi-layer controller 128, and status reporter/alerter 129.

Preferably, the control module 120 communicates with individual network elements 115, 117, 119 and client managers 15b, as described previously. Element manager 123 interacts with each network element through intermediary aggregation and filtering elements (not shown) to discover network elements 115, 117, 119, acquire status and usage information form network elements 115, 117, 119, and to inject information and other control directives into network elements 115, 117, 119. The topology manager 124 acquires interconnection information from the element manager 123 and determines how network elements 115, 117, 119 are configured and interconnected. The multi-layer monitor 121 acquires real-time information from network elements 115, 117, 119 through element manager 123. The multi-layer monitor 121 also acquires additional information regarding routes, bandwidth utilization, and class of service allocation and use and provides this information to the route manager 125, the bandwidth manager 126, and the QoS manager 127, which are described below.

Preferably, the customer request manager 122 acquires requests from client managers 15b. For example, a request for 15 Mb/S of Class of Service 1 bandwidth at 50 milliseconds latency and 0.01 percent packet loss from transceiver 10a (located in Los Angeles) to transceiver 10b (located in San Francisco) via network element 119b and network element 119d.

The route manager 125 maintains information concerning routes and their usage, including virtual route facilities, Virtual Local Area Networks (VLANs), Virtual Storage Area Networks (VSANs), label switched paths, and any other route information as is known in the art. The bandwidth manager 126 maintains information concerning allocated bandwidth and its usage. The Quality of Service (QoS) Manager 127 maintains information concerning classes of service in use, and the bandwidth allocated to each class of service.

Preferably, the multi-layer controller 128 uses information arising from customer requests managed by customer request manager 122, topology manager 124, route manager 125, bandwidth manager 125, and QoS manager 127 to allocate bandwidth in particular classes of service to specific routes or data paths by driving network element 123 to configure, adjust, or reroute network elements 115, 117 and 119. The multi-layer controller 128 also provides status to appropriate client managers 15b via the status reporter/alerter 129. In one preferred embodiment, if the multi-layer controller 128 is unable to meet a particular request, the multi-layer controller 128 generates and provides alerts to client managers 15b via the status reporter/alerter 129.

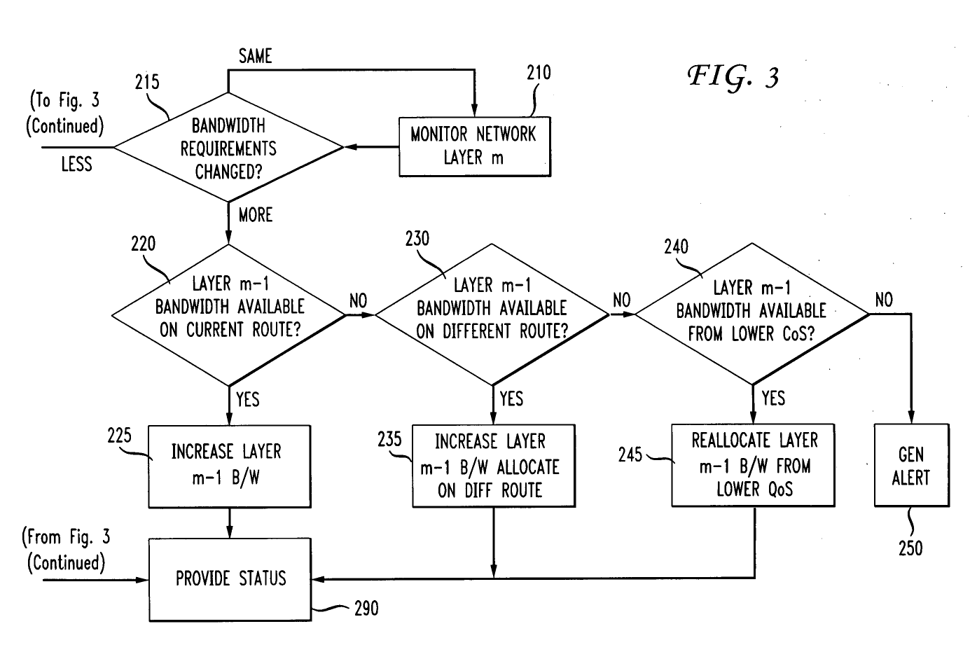

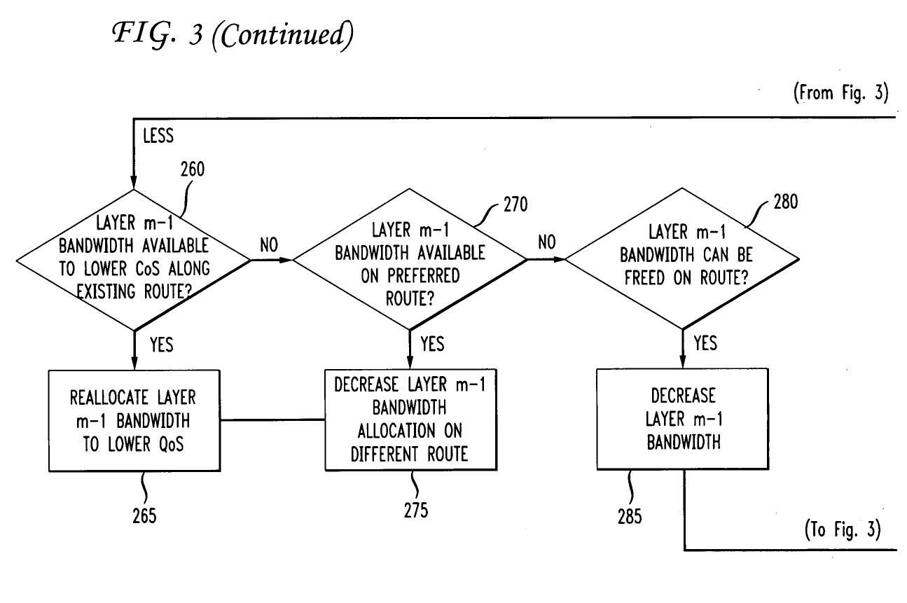

Referring now to FIG. 3, in one preferred embodiment, a method executed by the control module 120 to determine status between router pairs according to the present invention is shown. First, in step 210, the control module 120 monitors each network layer m. Next, in step 215, the control module 120 determines if any changes in bandwidth are required. If no changes in bandwidth are required, the control module repeats step 210. If the control module 120 determines that more bandwidth is required, based on either monitoring the network elements or through customer requests, the control module 120 proceeds to step 220.

In step 220, the control module 120 determines whether additional bandwidth is available from a lower layer on an existing data path. If so, in step 225, the control module 120 increases the bandwidth on the existing data path. If not, in step 230, the control module 120 determines whether there is bandwidth available for use on a different route. If so, in step 235, the control module 120 either can create the additional bandwidth or increase the bandwidth on the different data path. If not, in step 240, the control module determines whether bandwidth may be utilized on other available data paths from a lower class of service. If so, in step 245, the control module 120 reallocates the bandwidth to a higher class of service. If none of these options works, then in step 250, the control module 120 generates an alert.

If the control module 120 determines that less bandwidth is required, the control module 120 proceeds to step 260. In step 260, the control module 120 determines whether additional bandwidth needs to be allocated to a lower class of service along an existing route. If additional bandwidth needs to allocated to the lower class of service along an existing data path, the control module 120 allocates the bandwidth as shown in step 265. In addition, the control module 120 also determines if sufficient bandwidth at a correct class of service is available on a preferred route in step 270. If sufficient bandwidth at a correct class of service is available on a preferred route s, the control module 120 reallocates the bandwidth allocated on a less preferred route in step 275. In step 280, the control module 120 also determines whether bandwidth may be freed on any route and if so, the control module frees the bandwidth in step 285. Lastly, after any reallocation, reclassification, or rerouting actions are taken, the control module 120 provides a status of actions taken in step 290.

A number of embodiments of the invention have been described. Nevertheless, it will be understood that various modifications may be made without departing from the spirit and scope of the invention. For example, dedicated servers or virtual servers, collectively remote servers, may provide remote desktops and be organized or contained in various ways, and reside on multiple computers. Also, the steps described above may be modified in various ways or performed in a different order than described above, where appropriate. Accordingly, alternative embodiments are within the scope of the following claims.

What is claimed is:

1. A network controller comprising:
a computing device adapted to be operatively coupled to first and second network elements associated hierarchically in layers, the second network element comprising greater hierarchical priority than the first network element, the computing device adapted to modify allocation of a network resource in response to a request from the second network element.

2. The controller of claim 1, wherein the network resource comprises at least one of a route control, a bandwidth, and a Quality of Service.

3. The controller of claim 1, wherein at least one of the first network element and the second network element is selected from the group consisting essentially of an access router, edge router, core router, label switch, layer 2 switch, layer 3 switch, XML (extensible Markup Language) switch, dense wave division multiplexer, TCP/IP software stack, coarse wave division multiplexer, Asynchronous Transfer Mode (ATM) switch, frame relay access device, SONET multiplexer, inverse multiplexer, residential gateway, storage switch, storage virtualizer, optical cross-connect, reconfigurable optical add drop multiplexor, and wireless access point.

4. The controller of claim 1, wherein the computing device specifies routes for at least one of the first and second network elements.

5. The controller of claim 1, wherein the controller adjusts at least one of link capacity and end-to-end path capacity of at least one of the network elements.

6. The controller of claim 1, wherein the controller is adapted to modify the allocation of available bandwidth.

7. The controller of claim 1, wherein the controller monitors the first and second network elements.

8. The controller of claim 1, further comprising a plurality of transceivers adapted to send and receive network management information to at least one of the first and second network elements.

9. A method of controlling a network comprising:
modifying an allocation of a network resource in response to a request from a second network element operatively coupled in hierarchical layers with a first network element, the second network element comprising greater hierarchical priority than the first network element.

10. The method of claim 9, further comprising monitoring each of the first and second network elements.

11. The method of claim 10, further comprising:
determining whether additional bandwidth is available from the first network element on a data path between the first and second network elements; and
allocating the additional bandwidth on the data path based on the determination.

12. The method of claim 10, further comprising:
determining whether additional bandwidth is available from the first network element on a data path between the first and second network elements; and
allocating the additional bandwidth on an alternative data path based on the determination.

13. The method of claim 10, further comprising:
determining whether bandwidth is available from the first network element on a data path; and
reallocating the bandwidth on the data path to a different class of service.

14. The method of claim 10, further comprising generating an alert based on a non-availability of bandwidth from the first network element.

15. The method of claim 10, further comprising:
determining whether additional bandwidth is to be allocated to a lower class of service along a data path between the first and second network elements; and
allocating the bandwidth on the data path based on the determination.

16. The method of claim 10, further comprising:
determining whether a first amount of bandwidth associated with a class of service is available on a preferred data path between the first and second network elements; and
reallocating a second amount of bandwidth associated with a less preferred data path based on the determination.

17. The method of claim 10, further comprising providing a status of any allocation, reallocation, reclassification or rerouting of data paths between the first and second network elements.

18. An article comprising a machine-readable medium storing machine-readable instructions that, when applied to a machine, cause the machine to:
modify an allocation of a network resource in response to a request from a second network element operatively coupled in hierarchical layers with a first network element, the second network element comprising greater hierarchical priority than the first network element.

19. The article of claim 18 including instructions that, when applied to the machine, cause the machine to monitor the first and second network elements.

20. The article of claim 19 including instructions that, when applied to the machine, cause the machine to:
determine whether additional bandwidth is available from the first network element on a data path between the first and second network elements; and
allocate the additional bandwidth on the data path based on the determination.

21. The article of claim 19 including instructions that, when applied to the machine, cause the machine to:
determine whether additional bandwidth is available from the first network element on a data path between the first and second network element; and
allocate the additional bandwidth on an alternative data path based on the determination.

22. The article of claim 19 including instructions that, when applied to the machine, cause the machine to:
determine whether bandwidth is available from the first network element on an existing data path; and
reallocate the bandwidth on the data path to a different class of service.
